(19) United States
(12) Patent Application Publication
(10) Pub. No.: US 2016/0140808 A1
(43) Pub. Date: May 19, 2016

(54) Device, System and Method for Conducting a Wagering Game

(71) Applicants: Kenneth Alan Scott, Las Vegas, NV (US); Matthourasy Soubannarath, New York, NY (US)

(72) Inventors: Kenneth Alan Scott, Las Vegas, NV (US); Matthourasy Soubannarath, New York, NY (US)

(21) Appl. No.: 14/873,136

(22) Filed: Oct. 1, 2015

Related U.S. Application Data
(60) Provisional application No. 62/058,664, filed on Oct. 2, 2014.

(51) Int. Cl. G07F 17/32

(52) U.S. Cl. CPC G07F 17/3258; G07F 17/3276; G07F 17/3293

(57) ABSTRACT

A game device or a plurality of gaming devices are in communication with one another through a server, application, website or other means. Each gaming device executes a gaming method based on the precepts of mahjong. An ante and/or progressive bet is received. First to play is designated and hands of cards are dealt. Bet options and election of subsets of discards are received. Replacements for discards of equal subset number are dealt and received. Additional bet options may be received before constructing and displaying a final hand based on mahjong rules modified for the game method. The final hand is compared to predefined standard which optionally could be a paytable, a dealer hand, or the hand of at least one additional player to determine a game outcome.

### RELATED APPLICATION DATA

The present application claims the priority of U.S. Provisional Application Ser. No. 62/058,664, entitled “Jackpot Mahjong,” filed Oct. 2, 2014.

### BACKGROUND OF THE INVENTION

Mahjong has become one of the world's most popular games, especially in Asia, since its invention in China in the 1800s. While the game is usually played with tiles, it can also be played with cards with appropriate markings.

Mahjong decks or sets traditionally have 108 suited, 16 winds, 12 dragons, and 8 bonus cards or tiles for the total of 144 cards/tiles. There are three suits (circles, bamboos, characters) that are numbered one through nine with four of each card/tile for a total of 108 suited cards/tiles. There are four directions or “winds” cards/tiles (East, West, North, South) with four copies of each for a total of sixteen winds cards/tiles. There are three “dragon” cards/tiles of three colors (Red, Green, White) with copies of each for a total of twelve dragon cards/tiles. Lastly, there are eight “bonus” cards/tiles consisting of four different “flower” and four individual “season” cards/tiles. Other decks have differing numbers of various card categories dependent on local rules.

In traditional mahjong, cards/tiles, often thirteen but the number varies with various rules, are dealt to each of four players. Drawing and dealing mechanisms commence with the objective to build a winning hand of fourteen cards/tiles consisting of four sets and one pair. Sets are either three identical cards/tiles in both number and suit or three consecutively numbered cards/tiles of the same suit. The constitution of winning hand of mahjong can vary by number of tiles/cards or by number of sets and other various or special combinations of cards/tiles as determined by the rules of the variation being played. There are many additional bonus hands like all winds, all dragons, or winning with a hand consisting of a single suit.

Mahjong has an estimated ten times more players worldwide than poker according to recent studies. The game of mahjong is the official National Sport of the People's Republic of China and is played by hundreds of millions in a variety of cultures throughout the world. The pervasiveness of mahjong in these multiple cultures has led to derivations in game play, rules, and deck construction between cultural versions, but there are far more universal elements that are shared by all forms of mahjong.

The Invention is a new form of mahjong designed for play in licensed gaming establishments. It is also a marketing tool to draw the huge untapped mahjong player base onto casino tables. The Invention targets this unprecedented player base with a new fast-paced casino version of their favorite game for casino floors and card rooms.

There exist many obstacles to implementing traditional mahjong in a casino setting. First, traditional mahjong is slow to play. A full hand of traditional mahjong can take hours. Casinos demand a high rate of play with multiple hands of game dealt hourly. Therefore, the game has not been a viable option for casino floors. While mahjong halls are prevalent throughout Asia, these facilities do not require the rate of play from a game needed by casinos and other licensed gaming venues. Second, traditional mahjong is susceptible to collusion. This risk of collusion has kept the game out of casinos and card rooms. Players of traditional mahjong pull a portion of their hands from a communal pile of tiles or cards. As the players handle the cards or tiles and the players often act as teams, the possibility for collusion exists where certain tiles or cards are passed from one player to another to improve one or both players' hands to cheat other players.

### SUMMARY OF THE INVENTION

In one optional embodiment, the present invention includes a system. In one such optional embodiment, the system includes a plurality of gaming devices in communication with one another. Optionally, the system further comprises a server in communication with the plurality of gaming devices, wherein the server is operable to coordinate communication among the plurality of gaming devices. Optionally, each gaming device includes a gaming device processor, a display in communication with the gaming device processor, and a gaming device memory in communication with the gaming device processor.

The gaming device memory stores program instructions executable by the gaming device processor. In one such optional embodiment, the program instructions direct the gaming device to conduct a method that includes receiving from each gaming device an ante bet which is aggregated to a pot and a progressive bet. A designation is made of the first to play. A hand of cards is dealt to each gaming device. One of four bet options is received from each gaming device. The bet options comprise raise, check, call, or fold and surrender the ante and progressive bets. An election to discard a subset of cards is received from each hand, wherein the subset is fixed in quantity. A replacement subset of cards to each hand is dealt, wherein the subset contains the same fixed quantity of cards as the discarded subset, and displaying the replacement subset at the display. A selection of a quantity of cards is received from the replacement subset. The selection of cards from the replacement subset is replaced with an equal quantity of replacement cards. A selection of a final hand from the cards not previously selected to be discarded plus the replacement cards, wherein the final hand consists of fewer than all the cards available to form the final hand is received. Only one of four bet options is received from each gaming device for the final hand. The bet options comprising raise, check, call, or fold. When the last player making a raise has been called by at least one other player, the final hand is displayed for each gaming device. The final hands are compared. A fee is assessed from the pot. The pot minus the fee is issued to the gaming device with the highest ranking final hand.

In one optional embodiment, the present invention includes a gaming device. In one such optional embodiment, the device includes a gaming device processor, a display in communication with the gaming device processor, and a gaming device memory in communication with the gaming device processor.

The gaming device memory stores program instructions executable by the gaming device processor. In one such optional embodiment, the program instructions direct the gaming device to conduct a method that includes receiving from each gaming device an ante bet which is aggregated to a pot and a progressive bet. A hand of cards is dealt to each gaming device. One of four bet options is received from each gaming device. The bet options comprise raise, check, call, or fold and surrender the ante and progressive bets. An election to discard a subset of cards is received from each hand, wherein the subset is fixed in quantity. A replacement subset of cards to each hand is dealt, wherein the subset contains the same fixed quantity of cards as the discarded subset, and displaying the replacement subset at the display. A selection of a quantity of cards is received from the replacement subset. The selection of cards from the replacement subset is replaced with an equal quantity of replacement cards. A selection of a final hand from the cards not previously selected to be discarded plus the replacement cards, wherein the final hand consists of fewer than all the cards available to form the final hand is received. Only one of four bet options is received from each gaming device for the final hand. The bet options comprising raise, check, call, or fold. The final hand is displayed for each gaming device. The final hands are compared to a predefined standard. A fee is assessed from the pot. The pot minus the fee is issued to the gaming device with the highest ranking final hand.

Optionally, the gaming device memory is operative to store a pay table of final hands and associated payouts and the predefined standard is the pay table. In another optional embodiment, the device deals a dealer hand and forms a final dealer hand from the dealer hand wherein the predefined standard is the dealer hand. In another optional embodiment, the device deals at least one additional player hand and forms at least one additional final player hand from the additional player hand, wherein the predefined standard is the additional final player hand.

### BRIEF DESCRIPTION OF DRAWINGS

FIG. 1A is a top view depiction of the table of the house-banked version of the Invention game.

FIG. 1B is the player bet area on the table of the house-banked version of the Invention game.

FIG. 2 is the game play flow chart of a method for the house-banked version of the Invention game.

FIG. 3 is a top view depiction of the table of the player-banked (Player-banked) version of the Invention game.

FIG. 4 is the game play flow chart of a method for the Player-banked version of the Invention game.

FIG. 5 is a block diagram of a device for according to an embodiment of the present Invention.

FIG. 6 is a block diagram of a system for according to an embodiment of the present Invention.

### DETAILED DESCRIPTION OF THE INVENTION

In one optional embodiment, the present invention includes a method for conducting a wagering game. The wagering game may be implemented as a live table game or as an electronic game. Additionally, the present invention may be offered in either Player-banked and House-banked versions, but the dealing processes may be nearly identical.

The custom deck of the Invention and its method has 3 suits (Coins, Bamboo, & Characters) numbered 1 through 9. There are also 3 Dragons (White, Green, & Red) that outrank any numbered card but have equal ranking to each other. There are 5 of each card making for a total deck count of 150 cards. This custom deck is used in all versions of the Invention game however the deck is not limited to additions to accommodate future game rules.

For example in an optional embodiment of the custom deck and its construction, the number of individual cards may be increased or decreased for a larger or smaller total of cards than in the described custom deck with a total deck count of one hundred fifty (150). With eight (8) cards of each individual card, the total deck count of the custom deck totals two hundred forty (240) total cards. With three (3) cards of each individual card, the total deck count in the custom deck totals ninety (90) total cards.

Additional cards may be added to the custom deck, including but not limited to Dragons, wild cards, either as Jokers or specifically indicated or selected card(s) from within the custom deck, additional card types as are found throughout traditional mahjong, additional card types found in other card games, and/or specific cards invented for the alteration or achievement of a game goal. For example, a traditional American Mahjong deck may also be used with a 154 card count with jokers.

In an optional embodiment, multiple custom decks may be combined in a card shuffler in a live, electronic, or virtual setting. The combination of decks allow the formation of certain hands unattainable with a single deck as in six (6) or more of a kind as well as making other hands easier to hit due to the additional cards. The combination of decks also allows the offering of bets and side bets that cannot be offered or that are achieved substantially less with a single custom deck. The combination of decks also allows more than five (5) players to play the game as described as combining two (2) decks for a total deck count of three hundred (300) facilitates play of up to thirteen (13) players at one (1) table when the game format maximizes cards dealt and drawn at twenty three (23) cards per player per hand.

In one optional embodiment, regardless of the implementation, the game may be conducted as follows:

Thirteen (13) cards are dealt to each player.

Five (5) cards are discarded.

5 cards are displayed face-up for each player.

Player selects all, some, or none of the 5 face-up cards.

Dealer deals # of cards not selected so player receives a total of 5 new cards.

Players discard 5 cards to make a final hand of eight (8) cards.

In further optional embodiments, the number of cards dealt to, drawn by, or held by a player whether during the initial deal, the first, second, or third or later round of drawing or at the conclusion of a dealt hand may vary between various game embodiments. The variance in number of cards dealt, drawn, and/or kept allows for game objective hands either greater than or less than the eight (8) card final game objective hand in the embodiment described herein. The number of cards dealt initially, drawn during play, and/or kept in a final game objective hand impacts the value of hand elements as receiving more cards through the dealing process makes achieving certain hand elements easier while conversely receiving fewer cards through the dealing process makes achieving certain hand elements more difficult which makes lower hand elements more valuable to the player.

In an optional embodiment, the number of drawing and discarding rounds in a given hand can be increased to allow for the building of game objective hands greater than the eight card final game objective hand in the embodiment described herein or the drawing and discarding rounds in a given hand can be increased to make achieving the eight card final game objective hand less difficult. Conversely, the number of drawing and discarding rounds in a given hand can be decreased to allow for the building of game objective hands less than the eight card final game objective hand in the embodiment described herein or the drawing and discarding rounds in a given hand can be decreased to make achieving the eight card final game objective hand more difficult.

In an optional embodiment, the player draws can originate from multiple locations including but not limited to the custom deck under control of the game dealer, the collection of discarded or mucked cards, or from card pools established for such a purpose.

Depending on the embodiment of the present invention, wagers may be received in various different forms. For example, in a Player-banked embodiment, the method uses a player vs. player betting structure with a rake. In one such optional embodiment, ante bets are placed before the 13 cards are dealt.

A “button” tracks first to play. Player with the button is the “Boss” and initiates betting at each step of the hand. After the initial 13 cards are dealt to each player, the Boss makes a forced bet of 2 times the ante. All other players have to option to call that bet or to fold and cannot raise the Boss's forced bet. The second round of betting (check, raise, call, or fold) occurs after the first 5 cards are displayed to each player. The third round of betting (check, raise, call, or fold) occurs after the final discard. Best hand wins the pot and the house collects a percentage from the pot as allowed by local rules and regulations.

In an optional house-banked embodiment, the method uses a player vs. house betting structure:

Ante bets (or all bets) are placed before the 13 cards are dealt.

A “button” can be used to track first to play.

The 1st player option (bet 1× ante or fold) occurs before the first discard.

The 2nd player option (bet 3× ante, check, or fold) occurs after the final discard.

Dealer reveals 20 cards and makes the best possible hand.

Player hands compared one-on-one against Dealer hand to determine individual winners.

Both versions of the Invention game offer the “8 Dragons Progressive” jackpot. In one such optional embodiment, an 8 Dragons Progressive is paid by taking a percentage of house edge or separate optional bet dependent on Player-banked or Pit format. Upon a hand with 5 or 6 dragons, a percentage of a progressive jackpot or a fixed pay from a table is paid. Upon 8 dragons, the entire progressive jackpot is paid.

In either embodiment above, the goal of the method on the part of the player is the same. The highest ranking hand elements are formed to include “Trips” (also referred to as “Pungs,” which contain three cards of matching value and suit) or “Runs” (also referred to as “Chows,” which contain three cards in the same suit having consecutive values) through the steps of dealing and drawing (as described above) plus the highest pair possible. The game objective is to build the highest possible valued “complete” hand of 8 cards with 3 elements consisting of:

### 1 Suited Pair

### 1st Suited Trip or Suited Run

### 2nd Suited Trip or Suited Run

Any Suited Trip beats every Suited Run.

Highest element in a hand wins the game with:

Highest element ties move to second element with highest winning
Second element ties move to third element with highest winning

Any complete hand beats every incomplete hand.

Incomplete hands considered only if there are no complete hands with:

Player with most complete hand elements wins

In an optional embodiment, players must achieve the standard of a defined complete hand in order to be eligible to win a hand. Also once achieving a complete hand, the player could have no option but to stay for all rounds of betting until hand resolution.

In optional embodiments, the game objective may be defined differently than the game described herein. For example, the game objective may be defined as attaining the lowest three (3) card element (suited run of 1, 2, 3) in a complete hand in order to win all or a portion of the pot with the perfect low hand of one pair suited, run of 1, 2, 3 suited, and a run of 1, 2, 3 suited or other construction. Low trip could also be a rule parameter in an embodiment. Ranking of low hands could also start with the pair of a complete hand making a pair of suited ones the best low pair. The operation of the method could essentially remain the same as above.

In another optional embodiment where the game objective differs from the game described herein, the hand with the highest three (3) card element and the hand with the lowest three (3) card element evenly divide the pot at the completion of the hand. In another optional embodiment where the game objective differs from the game described herein, the hand with the highest three (3) card element and the hand with the lowest pair evenly divide the pot at the completion of the hand which provides the opportunity for one player to win both hands and take the entire game pot.

In another optional embodiment or interjected as a game feature in any of the enclosed game embodiments, qualifying hands may be used to establish the minimum hand to win either a high hand game or pot, a low hand game or pot, or either or both.

In another optional embodiment, the drawing procedure may be altered from the drawing procedure described herein by not exposing any cards drawn to make all players blind to all opponents' cards or the drawing process may be eliminated completely.

In another optional embodiment, “community cards” may be dealt to a specified table or game play area with said cards to be used by the players in a dealt hand. The number of community cards may vary as well as their display as per the embodiment game rules but the card display may assume a geometric shape or grid. If said grid is three (3) cards by three (3) cards for a total of nine (9) community cards, players may be limited by game rule to using three (3) cards in either a horizontal, vertical, or diagonal row for use in their hand. Game rules could also allow players to use any or none of the community cards in their hand. Alternatively, players may be forced to use “x” number of cards in their hand and “y” number of the community cards to build their final hand.

In optional embodiments, the construction and definition of winning hands may vary to accommodate hands of different numbers of cards than the eight (8) cards in the game described herein and additional drawing and dealing rounds as either allows the building of hand elements unattainable with fewer cards and/or drawing rounds. With these hand elements as possible outcomes in an embodiment, the construction of a winning hand may be altered to encompass the possible outcome(s). Any combination of cards or hand elements in any number of cards in a designated final hand can be defined to have achieved a game winning element or game hand.

In an optional embodiment where the final card hand total is greater than eight, the combination of hand elements for a winning hand will be in different combinations from the game described herein which could lead to multiple combinations of defined elements to achieve a winning hand. For example, a fourteen card hand could be resolved in multiple combinations of which any combination could be deemed to be a winning hand including: (all suited) 1 pair and 3 trips; 2 pairs, 2 trips, and 1 four of a kind; 1 pair, 1 trip, 1 four of a kind, and 1 five of a kind, and; so forth. In the optional embodiments with final card hand totals are greater than eight cards, any total may be used as the final hand card total and any mathematical arrangement of hand elements may be used to total the card hand total.

In another optional embodiment, players can achieve a “Kong” (4 of a kind of the same suit) and play it within their hand of eight cards or extend their number of cards to nine. A Kong would outrank any Trip. Achieving a Kong could release the player from the requirement of holding a complete hand to win or the rules for a complete hand could be adjusted to accommodate a Kong and other combinations of elements or the number of cards in a complete hand could be expanded to nine or ten if one or two Kongs are played, respectively. Kongs would also be played in game embodiments when the final hand card count would total any number greater than eight.

In another optional embodiment, players can achieve a “Woong” (five of a kind of the same suit) and play it within their hand of eight cards or extend their number of cards to nine or ten. A Woong would outrank any Trip or Kong. The term “Woong” is a combination of the word for the number five in Mandarin (“woo”) and the word for the number five in Cantonese (“ng”) and translates as “prosperous.” Achieving a Woong could release the player from the requirement of holding a complete hand to win or the rules for a complete hand could be adjusted to accommodate a Woong and other combinations of elements or the number of cards in a complete hand could be expanded to ten if two Woongs are played. Woongs would also be played in game embodiments when the final hand card count would total any number greater than eight.

In one optional embodiment, an optimum strategy may be defined which based on a mathematical and logical progression in the processes of discarding and drawing in the Invention game. The optimum strategy of discarding is determined by the numerical values and rankings of the dealt cards, the interaction of those values and rankings to the game objective, and the inherent logic that demands certain values are discarded and other values are held to have the highest probability of not only achieving the game objective of a complete hand but to also increase the values and rankings of elements within any hand to achieve victory by the game rules. As stated, the goal of the dealing and drawing in the game described in detail herein is achieving a “complete” hand consisting of one suited Pair, and two suited Trips, two suited Runs, or one suited Trip and one suited Run.

Upon receiving the initial thirteen cards to a hand, a Player would naturally hold as many as possible of any complete elements dealt such as a suited Trip, a suited Run, or a suited Pair. The terms Trips, Run, and Pair will be used herein interchangeably with a suited Trip, a suited Run, or a suited Pair.

The Player would also hold the highest ranking complete element when presented with a choice between complete elements. As any Trip beats every Run, Trips are held over Runs.

Trips are held in descending order of rank starting with three Dragons of any same color followed by three 9s of any same suit through three 1s of any same suit. Runs are held from highest (9, 8, 7 of any same suit) to lowest (3, 2, 1 of any same suit). Pairs are held from highest (Dragons of any same color) to lowest (Is of any same suit) for two reasons. First, the highest possible Pair is held for its numerical value and ranking as a complete element to a complete or incomplete hand. Second, as Trips are the highest ranking element and the ranking of a Trip against other Trips is based on its numerical or ranking value, Pairs are held according to value and rank based on the probability of drawing a third matching card to the Pair to achieve the highest possibly valued and ranked Trip within a given hand.

Consecutive cards of the same suit are the next category in the progression to be held. The most desirable consecutive cards can be completed into a Run with the addition of a third consecutive cards or either the high or low end of the first two consecutive cards.

The next category in the progression to be held is noncontiguous cards of the same suit that are separated by only one card. The highest ranking example is the 7 and 9 of any same suit. This example is held to allow the possibility of an 8 of that same suit to be drawn to the hand. This category of noncontiguous cards of the same suit that are separated by only one card are held from highest as above to lowest (3 and 1 of any same suit). This category also includes contiguous cards of the same suit that have only one possible card to complete a Run. These examples are 8 and 9 of any same suit and 2 and 3 of any same suit and would be held in descending order. The first example can only be completed as a Run with the drawing of a 7 of the same suit. The second example can only be completed with the drawing of a 1 of the same suit.

The last category in the progression to be held would be single cards in descending order. These are held as a last resort to match the highest possible pair through the drawing or the more remote possibility of drawing a Pair to the single card.

The mathematical complexity of the drawing process is explained above in its widest possible terms but it is robotically precise in proper procedure. This precision and complexity increase exponentially in the later rounds of drawing and discarding within the method. Optimum strategies have been fully calculated but are too lengthy to include herein.

The Invention is embodied as a method, a device, and as a system in both the player-banked version and the house-banked version of the Invention game.

The game objective of the Invention and its method is to build the highest possible valued “complete” hand of eight cards with three elements consisting of (all suited) one Pair and two Trips, two Runs, or one Trip and one Run. Any Trip beats every Run. The highest element in any hand wind the wins the game. On a tie of the highest ranking element, the second elements are compared. On a tie on the second element, the third element is compared. Any complete hand beats every incomplete hand. Incomplete hands are considered only if there are no complete hands. Other embodiments include the ability to achieve a Kong or 4 of a kind of the same suit, play the Kong in the hand of eight cards, expand the hand to nine or ten or more cards, or adjust the definition of a complete hand to allow for play of a Kong or Woong or other rule adjustment to allow for the incorporation of Kongs or Woongs into Invention game play.

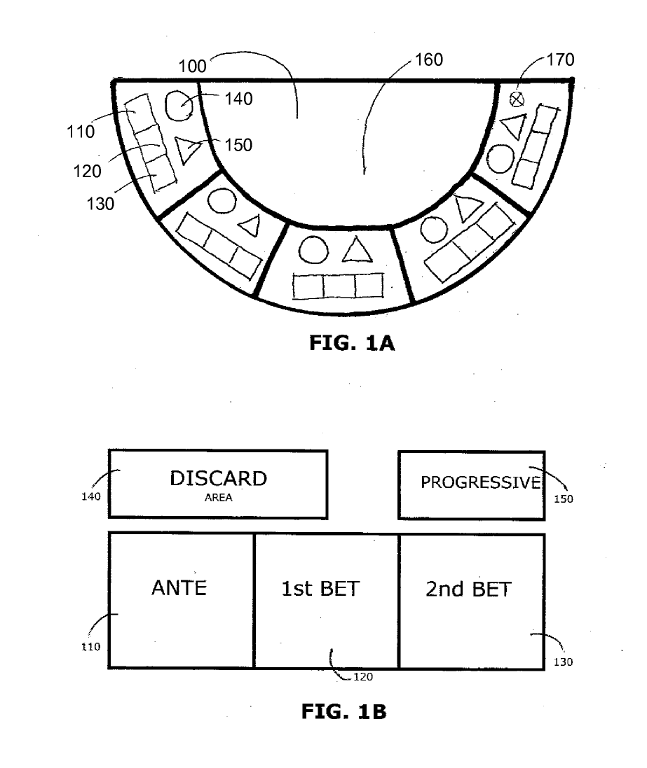

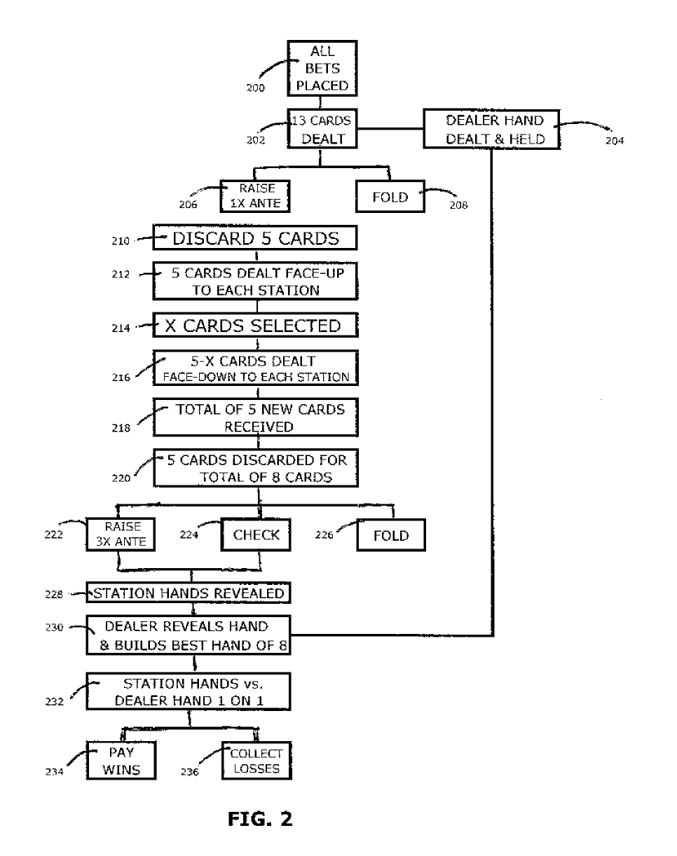

Turning to FIG. 1A, an optional gaming layout 100 for play of a house-banked card game according to an optional embodiment of the present method is illustrated that segments a standard sized Blackjack table into five player areas 100 although the number of players is not limited by the number of player areas depicted. The layout 100 consists of a wager and play section 110, 120, 130, 140, and 150 for each player and a play section for the dealer 160. According to the optional embodiment illustrated in FIG. 1B, the wager and play section includes Ante 110, first bet 120, second bet 130, discard area 140, and the progressive bet 150 in each player segment.

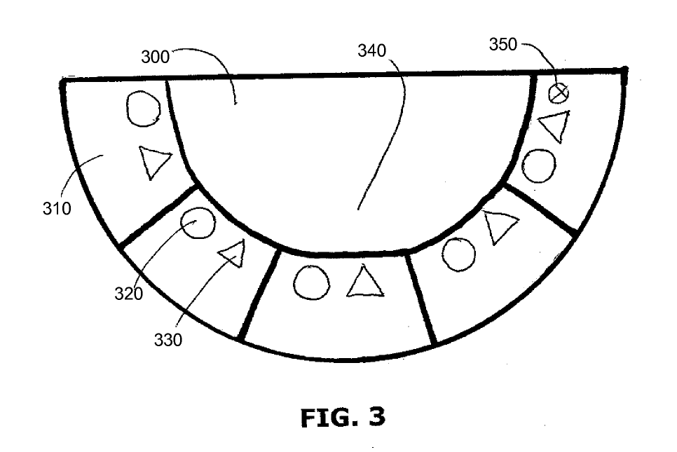

Turning to FIGS. 1B and 2, the game play and dealing of an optional method for the house-banked version of the Invention game is depicted in a flow chart and operates as follows:

1. All bets including Ante 110, first bet 120, second bet 130, and progressive bet 150 are placed before cards are dealt 200.

2. A button 170 designates first to play.

3. 13 cards are dealt to each gaming device counterclockwise 202.

4. Dealer deals 20 cards face down into Dealer area 160 for Dealer hand 204.

5. 2 bets:
First bet equaling one times the Ante bet 206;
Fold and surrender Ante and progressive bets and take down 1^{st} and 2^{nd} bets 208.

6. 5 cards discarded 210.

7. 5 card dealt face up in rotation 212.

8. “x” number of cards selected from face-up cards 214.

9. 5 minus x cards dealt face-down 216.

10. Total of 5 new cards dealt to each gaming device 218.

11. 5 cards discarded for a final hand total of 8 cards 220.

12. 3 bets:
Make second bet equaling 3 times the Ante 222;
Check and pull back the second bet 224;
Fold and surrender Ante, first, and progressive bets and take down 2^{nd} bets 226.

13. Gaming device hands are revealed 228.

14. Dealer turns over Dealer cards 204 and arranges the best hand from those 20 cards 230.

15. All gaming device hands compared to Dealer hand 232.

16. Wins are paid 234.

17. Losses are collected 236.

18. Button 170 advances counterclockwise or clockwise dependent on local rules.

In the instance that casino security disapproves of placing bets 120 and 130 with the Ante bet 206 or pulling back those bets with folds, players may also place the bets in the natural progression of the game.

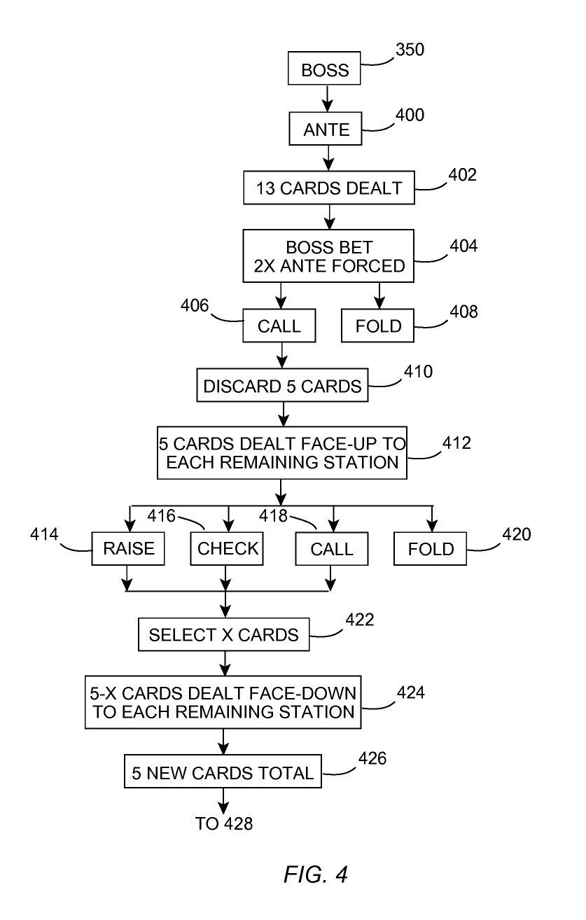

Turning to FIG. 3, an optional gaming layout 300 for play of a player-banked card game according to an optional embodiment of the present method is illustrated that segments a standard sized Blackjack table into five (5) player areas 300 although the number of players is not limited by the number of player areas depicted. The layout 300 consists a wager and play section 310, 320, and 330 and a dealer area for bet collection and card manipulation area 340. According to the optional embodiment illustrated in FIG. 3, the player wager and play section 310, discard area 320, and the progressive bet 330 are in each player segment.

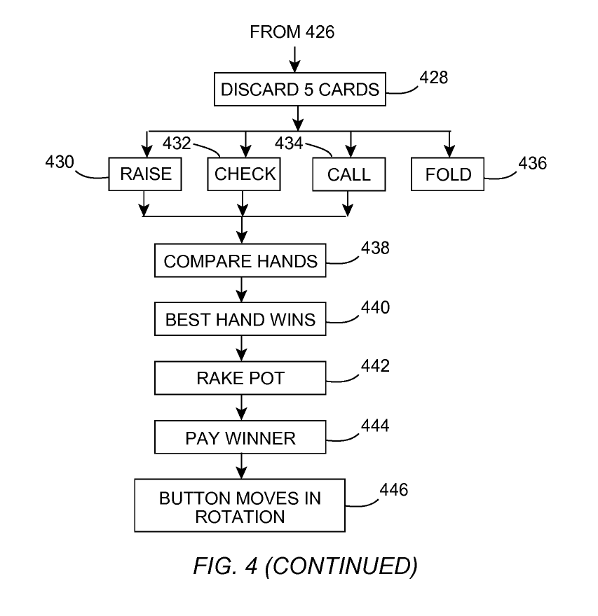

Turning to FIGS. 3 and 4, the game play and dealing of an optional method for the player-banked version of the Invention game is depicted in a flow chart and operates as follows:

1. A button 350 designates first to play.

2. Ante and progressive bet 400 are placed before cards are dealt.

3. 13 cards are dealt to each gaming device counterclockwise or clockwise dependent on local rules 402.

4. Player with button 350 (the “Boss”) has a forced bet of 2× the ante 404 as a forced bring in.

5. All other players have option of calling 406 or folding 408.

6. 5 cards 410 discarded into discard area 320 by each player.

7. 5 card dealt face-up in rotation 412.

8. 4 bet options:
Raise 4× ante (3× per round) 414 by Boss then others if Boss checks or folds
Check 416;
Call 418;
Fold and surrender Ante and progressive bets 420.

9. “x” number of cards selected from face-up cards 422.

10. 5 minus x cards dealt face-down 424.

11. Total of 5 new cards dealt to each gaming device 426.

12. 5 cards discarded into discard area 320 for a final hand total of 8 cards 428.

13. 4 bet options:
Raise 4× ante (3× per round) 430 by Boss then others if Boss checks or folds
Check 432;
Call 434;
Fold and surrender Ante and progressive bets 436.

14. When the last player making a raise has been called by some or all of the other players, the hands of the remaining players are revealed and compared 438.

15. Best player hand is determined 440.

16. A rake or other fees are subtracted from the pot for the house profit 442.

17. Winner is paid 444.

18. Button 350 and 446 advanced to next player counterclockwise or clockwise dependent on local rules.

In optional embodiments of the player vs. player game, varying limit betting structures may be employed including “No Limit” structures. These bets may be placed in the same order as the above method descriptions, but may also be moved, retracted, or supplemented in their placements and number.

In optional embodiments, the betting amounts and betting structures may be varied including but not limited to: the multiplier of the amount required to stay at each stage of the house-banked game; the number of raises and the levels by which a player can raise in the player-banked game, and; the handling of bets once placed or pulled down with folds or staying in place with checks. Bets or betting rounds may be added or subtracted at any stage of progression in any of game derivations contemplated herein. Pots may be forced to rollover into the next hand of dealing if no winning qualifying hand is achieved by any player when such qualifying hand is established as a game rule for that game embodiment.

It is contemplated that the present invention may be varied in alternate optional embodiments including the following side bets or progressives or pay tables on different elements or certain designated hands or any derivation of the following list.

For example, a side bet on the occurrence of a Kong (suited 4 of a kind) achieved by a player or dealer could be funded by a small percentage of house edge that could pay with each occurrence, with more than 1 Kong, or with special Kongs like Dragons or a specified number and/or suit. Kongs could be part of a group bet that pays from a paytable with a range of specified hands. Kongs could also pay a bonus upon occurrence with no extra side bet to players staying to the end of a hand or to all players. Kongs could also be ranked to defeat all trips and a player may not need a complete hand to win or may need just one other two or three card element.

For a further example, Woongs (suited 5 of a kind) could be handled similarly to or exactly as Kongs in the above example with special hands and rankings, bonuses or side wager(s).

An additional alternate embodiment of a side bet or game would be a “junk” or a “Laap Laap” bet where the player bets that either no element of a hand is achieved or that a complete hand is not achieved by that player or by any player at the table or that the dealer in the house-banked version does not make a complete hand. The Laap Laap bet would be similar to insurance in Blackjack and may be part of a group bet that pays from a paytable with a range of specified hands.

An additional alternate embodiment of a side bet or certain designated hand is an eight card final hand consisting all of one suit. This hand may or may not be a complete hand or organized in accepted hand elements. This singularly suited hand may or may not be ranked higher than other complete or incomplete hands and may or may not create an automatic win for its player. One suit final hands may be part of a group bet that pays from a paytable with a range of specified hands.

An additional alternate embodiment of a side bet or certain designated hand is an eight card final hand consisting of a contiguous run from one through eight or two through nine. These contiguous runs may or may not be all of one suit except within its inclusive runs that count as a hand element. This contiguous eight card run may or may not be ranked higher than other complete or incomplete hands and may or may not create an automatic win for its player. A contiguous eight card run of the same suit would be ranked higher than an eight card contiguous run with differing suits but contiguous numbers. Contiguous runs would also be able to be played in hands of greater than eight cards and may be part of a group bet that pays from a paytable with a range of specified hands.

An additional alternate embodiment of a side bet or certain designated hand is an eight card final hand containing suited four, five, six, or seven card runs. These runs may or may not rank higher than trips and may or may not create an automatic win for its player. Suited four, five, six, or seven card runs would also be able to be played in hands of greater than eight cards and may be part of a group bet that pays from a paytable with a range of specified hands.

An additional alternate embodiment of a side bet or certain designated hand is an eight card final hand containing a variety of suited or numerically matched pairs and trips. For example, a hand can contain trips of one number and a pair of the same suit and number. A hand could also contain trips that match in number but not suit. A hand could also contain a trip and a pair that match numerically but not in suit. A hand could also contain four pairs. In any of these or similar outcomes, a bonus pay could be made to the specific player with the specified hand, all players without an extra bet, all players who stayed to the end of the hand, or only to players making a side bet on this occurrence or on a group of occurrences.

An additional embodiment of a game feature gives the players the option to purchase a set number of additional cards to supplement their hands for a set fee. This “Buy Round” would be followed by an additional round of betting in any derivation of the invention game.

A standard six sided die or pair of dice may be used to determine first to play or other game procedure.

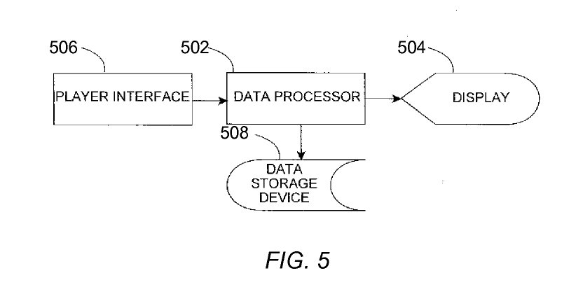

As illustrated in FIG. 5, a method according to an embodiment of the present invention may be implemented using a device. In one optional embodiment, the device only serves to produce random outcomes. Such a random outcome generator may take the form of a playing card shuffler incorporating a random number generator that randomizes playing cards and, optionally, deals randomized hands. Alternatively, a device may perform additional tasks aside from producing random outcomes, such as displaying hands, evaluating and comparing hands, receiving input, and the like. Again, as noted above, such a device may take the form of an electronic gaming machine, electronic table or electronic table system, mobile phone, tablet device, handheld device, or the like.

For example, in one such optional embodiment, a device includes a processor 502 in communication with a display 504, an interface 506, and a data storage device 508. Wagers are received or designated through an interface 506. Such an interface 506 may take any form, including a button panel, keyboard, keypad, or the like. In a further optional embodiment, the interface 506 and display 504 may be combined into a touch screen device. In response to the Ante wager, a random outcome is generated by a random outcome generator. In one such optional embodiment, the random outcome generator is a software, firmware, or hardware random number generator working in concert with a processor 502 that maps random numbers generated by the random number generator to outcomes, such as playing cards or playing card combinations.

The display 504 may take any form, including a plasma display, liquid crystal display (“LCD”), organic light emitting diode (“OLED”) display, cathode ray tube (“CRT”) monitor, mechanical reels, or the like. As may be appreciated, in a gaming device with an electronic display, the game may be accompanied by animation to provide entertainment during the course of the game.

An initial player hand is selected by the random outcome generator and displayed at the display 504. Optionally, a dealer hand is likewise selected by the random number generator and displayed at the display 504. It is contemplated that the device may be configured for multiple players with each player having his or her own display 504. Alternatively, the device may be configured for multiple players sharing a display 504. In yet another optional embodiment, the device may be configured for a single player and a single display 504. It is also contemplated that a dealer hand may be displayed at a separate display or on the same display as the player hand(s).

In one optional embodiment, a processor 502 may determine whether the initial player hand is a target hand based on a target hand pay table stored at a data storage device 508. If so, a target hand payout may be issued. Again, the target hand payout may be issued in addition to any other payout.

A final player hand is formed substantially as described above, with elections to discard and draw cards and bet, call, check, or fold as above received through the interface 506. In an optional embodiment, a processor 502 evaluates the final player hand to determine if it matches a target hand as stored in the target hand pay table at a data storage device 508. If so, the target hand wager may be resolved by paying a target hand payout based on a pay table stored at a data storage device 508. As discussed above, the hand payout and game resolution is contingent on a comparison of the final player hands between each other, between each player hand with the final dealer hand or, alternatively, may occur instantly independent of the final dealer hand. If neither the initial player hand nor the final player hand is a target hand, the target hand wager may be collected by the processor 502.

The highest ranking hand as determined by the game rules is calculated by processor 502 to determine which player won the hand or if a player hand defeated a dealer hand dependent if the Invention game is in its player-banked version or the house-banked version. Winning hands are paid and losing bets are collected through the processor 502. These results are conveyed to display 504 and possibly stored 508 for player tracking and the like.

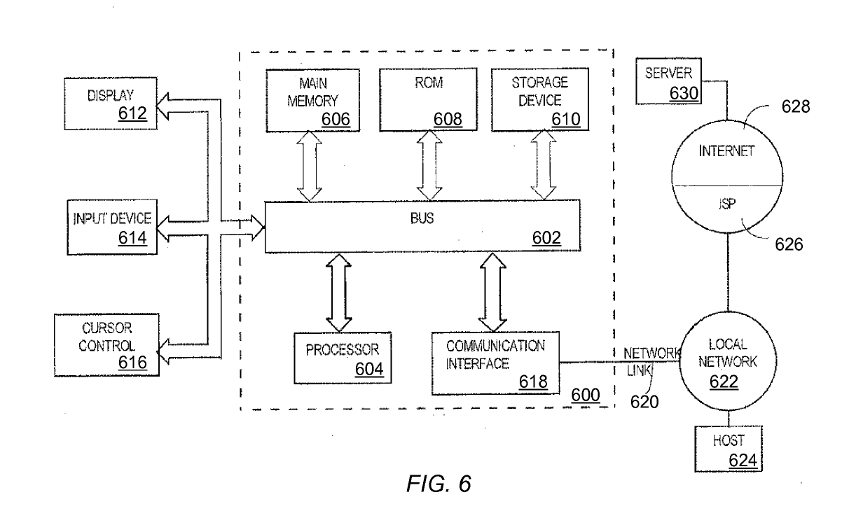

The Invention is also embodied in a system for networking through the Internet, smart-phone applications, and any other means of electronic system networking. For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), liquid crystal display (LCD), light emitting diode (LED), plasma, or the like, for displaying information to the user of a computer, electronic gaming machine, electronic table or electronic table system, mobile phone, smartphone, tablet device, handheld device, or the like. An input device including but not limited to a computer, electronic gaming machine, electronic table or electronic table system, mobile phone, smartphone tablet device, handheld device, or the like 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Nonvolatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CDROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infrared data communications.

Various forms of media may be involved in carrying one or more sequences of one or more instructions to processor 604 for execution. For example, the instructions may initially be carried on a magnetic disk or solid state drive of a remote computer.

The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage device 610, or other non-volatile storage for later execution.

Game play proceeds as detailed above when an Ante wager is received by input device 614. That information is transmitted to bus 602 to processor 604 to communication interface 618 through the network link 620 to a local network 622 and its local host 624 to an ISP 626 on the Internet 628 to a server 630 where the information is recorded and game play ensues. Game play proceeds as above. Game play and other information is sent back to the input device in reverse order as above and is transmitted back and forth between the server and the input device until the game play is resolved by the game rules within the server or at any other appropriate or possible junctures in the above system.

In the various optional embodiments described, a game may be provided which is based on the game of mahjong but provides the rate of play or hands per hour desired by casinos. Additionally, the various optional embodiments of the present invention reduce or eliminate the risk of player collusion that can occur in the traditional game of Mahjong. At the same time, players of traditional mahjong will instantly recognize elements of mahjong in the deck construction, game objective, dealing, discarding, and drawing as described in the various optional embodiments of the present invention.

While certain embodiments of the present invention have been shown and described it is to be understood that the present invention is subject to many modifications and changes without departing from the spirit and scope of the claims presented herein.

I claim:

1. A system comprising:
a plurality of gaming devices in communication with one another, each gaming device comprising:
a gaming device processor;
a display in communication with said gaming device processor; and
a gaming device memory in communication with said gaming device processor which is operative to store program instructions executable by said gaming device processor to conduct the steps of:
receiving from each gaming device an ante bet which is aggregated to a pot and progressive bet;
designating first to play;
dealing a hand of cards to each gaming device;
receiving one of four bet options from each gaming device, said bet options comprising raise, check, call, or fold and surrender the ante and progressive bets;
receiving an election to discard a subset of cards from each hand, wherein the subset is fixed in quantity;
dealing a replacement subset of cards to each hand, wherein the subset contains the same fixed quantity of cards as the discarded subset, and displaying the replacement subset at the display;
receiving a selection of a quantity of cards from the replacement subset;
replacing the selection of cards from the replacement subset with an equal quantity of replacement cards;
receiving a selection of a final hand from the cards not previously selected to be discarded plus the replacement cards, wherein the final hand consists of fewer than all the cards available to form the final hand;
receiving one of four bet options from each gaming device for said final hand, said bet options comprising raise, check, call, or fold;
when the last player making a raise has been called by at least one other player, displaying the final hand for each gaming device;
comparing the final hands;
assessing a fee from the pot; and
issuing the pot, minus the fee, to the gaming device with the highest ranking final hand.

2. The system of claim 1 further comprising a server in communication with said plurality of gaming devices, wherein said server is operable to coordinate communication among said plurality of gaming devices.

3. A gaming device comprising:
a gaming device processor,
a display in communication with said gaming device processor; and
a gaming device memory in communication with said gaming device processor which is operative to store program instructions executable by said gaming device processor to conduct the steps of:
receiving through said gaming device an ante bet which is aggregated to a pot and progressive bet;
dealing a hand of cards;
receiving one of four bet options, said bet options comprising raise, check, call, or fold and surrender the ante and progressive bets;
receiving an election to discard a subset of cards from said hand, wherein the subset is fixed in quantity;
dealing a replacement subset of cards to said hand, wherein the subset contains the same fixed quantity of cards as the discarded subset, and displaying the replacement subset at the display;
receiving a selection of a quantity of cards from the replacement subset;
replacing the selection of cards from the replacement subset with an equal quantity of replacement cards;
receiving a selection of a final hand from the cards not previously selected to be discarded plus the replacement cards, wherein the final hand consists of fewer than all the cards available to form the final hand;
receiving one of four bet options for said final hand, said bet options comprising raise, check, call, or fold;
displaying the final hand;
comparing the final hand to a predefined standard;
assessing a fee from the pot; and
issuing the pot, minus the fee, to the gaming device with the highest ranking final hand.

4. The gaming device of claim 3 wherein said gaming device memory is operative to store a pay table of final hands and associated payouts and said predefined standard is said pay table.

5. The gaming device of claim 3 further comprising:
dealing a dealer hand; and
forming a final dealer hand from said dealer hand, wherein said predefined standard is said dealer hand.

6. The gaming device of claim 3 further comprising:
dealing at least one additional player hand; and
forming at least one additional final player hand from said additional player hand, wherein said predefined standard is said additional final player hand.
